(19) United States
(12) Patent Application Publication
(10) Pub. No.: US 2015/0225218 A1
(43) Pub. Date: Aug. 13, 2015

(54) Method Of Operating A Fork-Lift Truck, Computer Program Product, And A Fork-Lift Truck

(71) Applicant: BT Products AB, Mjoelby (SE)

(72) Inventor: Michael Strand, Mjoelby (SE)

(21) Appl. No.: 14/616,665

(22) Filed: Feb. 7, 2015

(30) Foreign Application Priority Data
Feb. 10, 2014 (EP) 14154568.1

(51) Int. Cl. B66F 9/075; B66F 9/065

(52) U.S. Cl. CPC B66F 9/075; B66F 9/065

(57) ABSTRACT

A method of operating a fork-lift truck includes steps to determine a hydraulic pressure signal P by means of the at least one detection device, wherein the hydraulic pressure signal P corresponds to an hydraulic pressure in, at least a section, of an hydraulic system of a fork-lift truck 1, transfer the hydraulic pressure signal P to an electronic load carrier unit, determine by means of the electronic load carrier unit whether the hydraulic pressure signal P adopts a value, within a predetermined value range Pval, determine by means of the electronic load carrier unit if a load carrier of the forklift truck is, at least partially, supported by an external object no being part of the forklift truck or a fixed internal object of the fork-lift truck, based on the determination whether the hydraulic pressure signal is within the predetermined value range Pval. Embodiments of the invention also include a computer program product and a fork-lift truck that can perform the method.

### CROSS-REFERENCE TO RELATED APPLICATIONS

The present application claims the benefit of European Patent Application No. 14154568.1 filed Feb. 10, 2014, which is fully incorporated herein by reference.

### STATEMENT REGARDING FEDERALLY SPONSORED RESEARCH OR DEVELOPMENT

Not applicable.

### FIELD OF THE INVENTION

The present invention relates to fork-lift trucks, in particular to a method of operating a forklift truck, a computer program product executing the steps of the method, and a fork-lift truck capable of executing the steps of the method.

### BACKGROUND OF THE INVENTION

When operating fork-lift trucks, the fork-lift truck is handled by an operator that either rides with the fork-lift truck or walks along the fork-lift truck. Generally pallets and/or goods are moved by the fork-lift truck by means of a load carrier, in general it is a pair of forks that enters in two slots of a pallet and then the forks are lifted and the pallet is lifted together with the forks. Then the fork-lift truck can travel a distance and the operator manoeuvres the fork-lift truck to lower its forks and then place the pallet and leave this position without a load. The fork-lift truck is then driven by the operator without an pallet and/or goods, to a new location. During this travel, the operator generally needs to raise/lift the load carrier/forks a small distance.

U.S. Pat. No. 7,287,625 B1 discloses a forklift truck, being a counter balance fork-lift truck, with an applied sensor and a control system for preventing unsafe wear on the tines of the fork. The sensor is described as measuring the height by means of for example an optical sensor, mechanical switch and it is mounted on the chassis or the mast of the forklift.

When moving a fork-lift truck, such as disclosed in U.S. Pat. No. 7,287,625 B1 it can be advantageous if the operator raises the load carrier a small distance. This is due to the fact that if the load carrier is left in a low position, when moving the fork-lift truck, the load carrier can touch the surface on which the fork-lift truck is traveling. The described operational circumstances of a fork lift truck can lead to a number of problems. One problem being that the load carrier an be damaged. Another problem can be that the load carrier's contact with the surface on which the fork-lift truck is travelling can lead to noise. A further problem with this behaviour of the operator can be that the energy consumption of the fork-lift truck is increased. Other problems can also be that the surface of a floor is damaged, or that the front of the load carrier can hit an obstacle that forces the fork-lift truck to stop unexpectedly, which can damage the load carrier or even hurt the operator. The damaged load carrier incur cost for maintenance, reparation etc., this also being true for a damaged floor or other external objects. A further advantage is that an additional position sensor device can be excluded, or need not be provided. This in turn provides for further cost savings.

The disclosed forklift has the disadvantage that the sensor is mounted externally on the forklift. This means that the sensor is subjected to the external surroundings of the forklift, and is thus subjected to wear in the case of a mechanical switch not only depending on the operation of the forks of the forklift, but also because of for example external involuntary actuation. For example a mechanical switch can be actuated unexpectedly by protruding goods or other external objects. An optical sensor may have its function disturbed or even ruined by for example oil or dirt that prevents it from sensing the optical input. Another disadvantage of the disclosed prior art is that the sensor is added to the forklift truck for giving the output for controlling the height, thus extra equipment needs to be added to the forklift truck. Another problem with the above disclosed prior art is that in a situation where it is not the ground or floor that the load carrier is resting on for example higher up in on as shelf, no action will be taken as it always relate to the ground.

### SUMMARY OF THE INVENTION

In order to solve at least one of the mentioned problems, the present invention provides in one embodiment a method of operating a forklift truck comprising the steps to: determine a hydraulic pressure signal P by means of at least one detection device, wherein the hydraulic pressure signal P corresponds to an hydraulic pressure in, at least a section, of an hydraulic system of a fork-lift truck; transfer said hydraulic pressure signal P to an electronic load carrier unit; determine by means of the electronic load carrier unit whether the hydraulic pressure signal P adopts a value, within a predetermined value range Pval; determine by means of the electronic load carrier unit if a load carrier of the forklift truck is, at least partially, supported by an external object not being part of the forklift truck or a fixed internal object of the fork-lift truck, based on the determination whether the hydraulic pressure signal is within the predetermined value range Pval.

The above method has the advantage that it uses an internally mounted sensor. It has also the advantage that it uses a sensor that is also in general installed in most fork-lift trucks for load weight measurement. The sensor is thus not subjected to any external environment, and it is also not possible to unintentionally damage the sensor as it is both positioned under the outer shell parts of the fork-lift truck, and also preferably screwed into the main hydraulics block of the fork-lift truck and thus can actually not be reached without disassembly and the use of tools. Thus the method makes use of a much protected sensor. Thus the method provides for that the fork-lift truck is monitoring whether the load carrier is either supported by an external object or if the load carrier is supported by a fixed internal object of the fork-lift truck. Thus it is an advantage that the method gives the possibility to evaluate and process a determined condition.

In a further development the following step IIIa between step III and IV is performed:

IIIa. Determine a time condition t, if P is within said predetermined value range; and proceed to step IV if said time condition t is fulfilled.

The advantage of step IIIa is that it better confirms that actually the load carrier is resting on an external object or a fixed internal object. If P fulfils Pval momentarily but for only a very short period step IIIa can filter away this indication such that unnecessary determinations of load carrier resting on an external object or fixed internal object are avoided.

In further development of the method time condition t is a predetermined time during which P has taken a value within the predetermined value range Pval.

This has the advantage that parameter t can be set according to the working conditions of the fork-lift truck on which the method is applied.

In a further development the electronic load carrier unit determines the hydraulic pressure signal P continuously.

This provides for a very brief and exact method that is not giving any unintentional messages to an operator, when conditions for disclosing an indicated message has lapsed.

In accordance with another aspect of the invention, a method of operating a fork-lift truck comprises the steps to determine a hydraulic pressure signal P by means of at least one detection device, wherein the hydraulic pressure signal P corresponds to an hydraulic pressure in, at least a section of an hydraulic system of a fork-lift truck; transfer said hydraulic pressure signal P to an electronic load carrier unit; determine by means of the electronic load carrier unit whether the hydraulic pressure signal P adopts a value, within a predetermined value range Pval; determine by means of the electronic load carrier unit if a load carrier of the forklift truck is, at least partially, supported by an external object not being part of the forklift truck or a fixed internal object of the fork-lift truck, based on the determination whether the hydraulic pressure signal is within the predetermined value range Pval, send an indication to an operator that the load carrier is supported by the external object or the fixed internal object of the fork-lift truck, if said load carrier is determined to be at least partially supported by the external object or the fixed internal object of the fork-lift truck.

This has the advantage that if the operator has not himself taken notice that the load carrier of the fork-lift truck is in a position where the load carrier is supported on an external object or an internal object of the fork-lift truck, the operator can get an indication of this, and act accordingly.

In accordance with a further development, the method further comprises the steps to send the indication that the load carrier is supported by the external object or the fixed internal object of the fork-lift truck to a control unit arranged to control operation of the fork-lift truck and step VIII, reduce by means of the control unit the maximal travel speed of the fork-lift truck while the load carrier is supported by the external object or the fixed internal object of the fork-lift truck. This step VIII has the advantage that an operator will get an incentive to remove the cause of the indication, as the fork-lift truck can only travel at a lover speed than the maximal travel speed.

In accordance with yet another aspect of the invention, a method of operating a fork-lift truck comprises the steps to determine a hydraulic pressure signal P by means of at least one detection device, wherein the hydraulic pressure signal P corresponds to an hydraulic pressure in, at least a section, of an hydraulic system of a fork-lift truck; transfer said hydraulic pressure signal P to an electronic load carrier unit; determine by means of the electronic load carrier unit whether the hydraulic pressure signal P adopts a value, within a predetermined value range Pval; determine by mean of the electronic load carrier unit if a load carrier of the forklift truck is, at least partially, supported by an external object not part of the forklift truck or a fixed internal object of the fork-lift truck, based on the determination whether the hydraulic pressure signal is within the predetermined value range Pval, send an indication to a control unit that is arranged to control operation of the fork-lift truck.

This has the advantage that the fork-lift truck can itself take action for the indication and prevent the load carrier to be damaged, in the event that the operator does not apply measures for remedy of the situation. This safeguards that the load carrier is not damaged by mistake. The fork-lift truck itself adjusts the load carrier, for example by raising it. Thus the operator is freed from making the adjustment himself, and can thus focus more on the operation of the industrial truck or his other assignments. The wear of the load carrier is inevitably further reduced, as the fork-lift truck becomes independent of the skills of the operator, for safe guarding an appropriate height of the load carrier, if supported by an external object.

In a further development the method comprises the step to initiate by means of the control unit a movement for removing the load carrier from the external object, preferably by lifting the load carrier.

In a further development the lifting is performed for a predetermined time period t22. This has the advantage that the operator need not interact in order to adjust or stop the movement. By adding a predetermined time period the lifting movement can be controlled, such that the load carrier is not lifted too far. That is to a height that is not appropriate for travelling or to a height where they risk interfering with another external object.

The discussed disadvantages is further at least partly solved by a computer program product comprising computer readable code, that when executed on an electronic load carrier unit performs the methods according to the above. Accordingly, the invention also relates to a computer program product, comprising computer readable code, that when executed performs the steps of determine a hydraulic pressure signal P by means of at least one detection device, wherein the hydraulic pressure signal P corresponds to an hydraulic pressure in, at least a section, of an hydraulic system of a fork-lift truck; transfer said hydraulic pressure signal P to an electronic load carrier unit; determine by means of the electronic load carrier unit whether the hydraulic pressure signal P adopts a value, within a predetermined value range Pval;

determine by means of the electronic load carrier unit if a load carrier of the forklift truck is at least partially, supported by an external object not being part of the forklift truck or a fixed internal object of the fork-lift truck, based on the determination whether the hydraulic pressure signal is within the predetermined value range Pval, and send an indication to an operator that the load carrier is supported by the external object or the fixed internal object of the fork-lift truck, if said load carrier is determined to be at least partially supported by the external object or the fixed internal object of the fork-lift truck.

The computer program product is particularly efficient for controlling the discussed method as it can be easily incorporated into an already present fork-lift truck.

In accordance with as further aspect of the invention relates to a fork-lift truck comprising: a hydraulic system; a load carrier; at least one hydraulic pressure detection device arranged to determine hydraulic pressure signal P corresponding to an hydraulic pressure in, at least a section, of the hydraulic system; wherein the forklift truck further comprises or is in communication with an electronic load carrier unit arranged to receive said hydraulic pressure signal P, to determine whether the hydraulic pressure signal P adopts a value, within a predetermined value range Pval; and to determine if the load carrier of the forklift truck is, at least partially, supported by an external object not being part of the forklift truck or a fixed internal object of the fork-lift truck, based on the determination whether the hydraulic pressure signal is within the predetermined value range Pval, and to send an indication to an operator that the load carrier is supported by an external object or a fixed internal object of the fork-lift truck, if said load carrier is determined to be at least partially supported by an external object or a fixed internal object of the fork-lift truck.

If, when the electronic load carrier unit is arranged aboard the fork-lift truck, the fork-lift truck is transported to a new location, the new location need not be adopted with any external equipment for housing an external electronic load carrier unit.

In accordance with one option, the fork-lift truck further comprises a control unit arranged to reduce the maximal travel speed of the fork-lift truck when it is determined that P=Pval, and optionally a time condition t is fulfilled. This has the advantage that the load carrier cannot be damaged in the same way as if the maximal speed was allowed to be higher. It has also the advantage that if the fork-lift truck does hit an object on the supporting ground of floor consequences of impact is reduced.

In accordance with another option, the fork-lift truck further comprises a communication device for communicating with the external electronic load carrier unit, preferably said communication device is arranged to be associated with said electronic load carrier unit by wireless communication. By having a communication device installed on the fork-lift truck the electronic load carrier unit can be an external device. This has the advantage that the electronic load carrier unit can be easier to perform maintenance on and further be easier to protect. And further the number of electronic load carrier units can be reduced if several fork-lift trucks are allowed to communicate with the same electronic load carrier unit.

In accordance with q a further aspect of the invention, it relates to a fork-lift truck comprising: a hydraulic system; a load carrier; at least one hydraulic pressure detection device arranged to determine a hydraulic pressure signal corresponding to an hydraulic pressure in, at least a section, of the hydraulic system; wherein the forklift truck further comprises or is in communication with an electronic load carrier unit arranged to receive said hydraulic pressure signal P, to determine whether the hydraulic pressure signal P adopts a value, within a predetermined value range Pval; and to determine if a load carrier of the forklift truck is, at least partially, supported by an external object not being part of the forklift truck or a fixed internal object of the fork-lift truck, based on the determination whether the hydraulic pressure signal is within the predetermined value range Pval, and wherein the fork-lift truck further comprises a control unit arranged to control the movement of the load carrier (4) based on the determination if a load carrier of the forklift truck is, at least partially, supported by an external object not being part of the forklift truck or a fixed internal object of the fork-lift truck.

Using the control unit arranged to control the movement of the load carrier has the advantage that the load carrier can be controlled without any mechanical interaction of the operator as the control unit itself can send commands to move the load carrier. In one option, the control unit is a main control unit that is arranged to control and monitor essentially all functions of said fork-lift truck, in particular wherever applicable, lifting, lowering, travel speed, safety functions, horn, weight limitations, height limitations, height pre-sets, acceleration, deceleration, power regeneration, display functions. This has the advantage that all functions of the fork-lift truck can be controlled by the same control unit, and thus maintenance and updating of software etc, is simplified.

In another option, the control unit is arranged to initiate a movement fur removing the load carrier from the external object, preferably by lifting the load carrier.

In yet another option, the electronic load carrier unit is incorporated into the control unit of the fork-lift truck. This has the advantage that no further hardware needs to be installed on the fork-lift truck. The control-unit thus needs only to have capacity to house the electronic load carrier unit. This provides for a simple and swift solution to provide for the present invention.

The advantages of the above fork-lift trucks are in essence described with regard to the method and computer program product described above. It should be understood that the fork-lift truck can be a modified older fork-lift truck having necessary components.

### BRIEF DESCRIPTION OF THE DRAWINGS

FIG. 1 discloses a scheme for the method according to the invention;

FIG. 2 discloses a fork-lift truck according to a first embodiment of the invention;

FIG. 3 discloses a fork-lift truck according to a first embodiment of the invention;

FIG. 4 discloses a fork-lift truck according to a first embodiment of the invention;

FIG. 5 discloses a fork-lift truck according to a second embodiment of the invention;

FIG. 6 discloses a further development of the method according to the invention; and

FIG. 7 discloses an embodiment of the method according to the invention.

### DETAILED DESCRIPTION OF THE EXAMPLE EMBODIMENTS

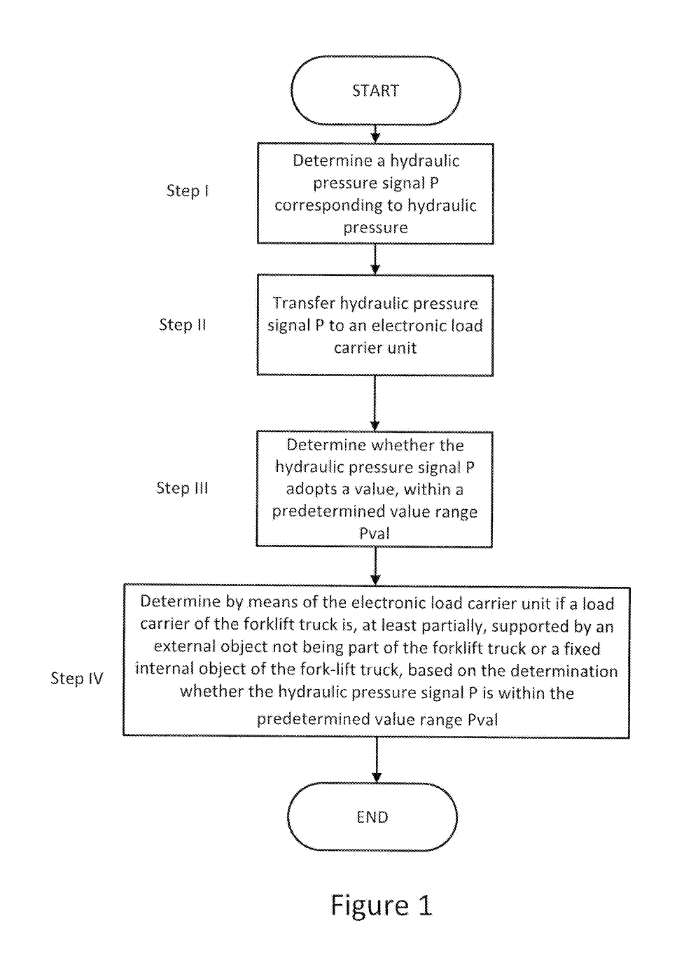

The invention relates to a method of operating a fork-lift truck as can be seen in FIG. 1. By fork-lift truck it should be understood a material handling device having a load carrier. Even if the load carrier is generally to be understood as two protruding forks, other configurations are thinkable. For example there can be more than one fork pair, and the fork pair can be replaced with another load carrying device without having impact on the method.

The method of operation relates to the determination of a hydraulic pressure signal P. The hydraulic pressure signal P thus corresponds to the hydraulic pressure in a hydraulic system of a fork-lift truck. It is known that most fork-lift trucks use a hydraulic system to operate different functions of the fork-lift truck. In particular raising and lowering of the load carrier.

From this it is clear that the description and invention does not relate to a fork-lift truck that has an alternative way of powering the load carrier for example by means of some complete wired lifting cf. an elevator.

The method also relates to a hydraulic signal P that corresponds to a hydraulic pressure P, in at least a section of the hydraulic system of a fork-lift truck. In order for the method to work properly the hydraulic signal P must relate to a hydraulic pressure that is actually affected by the load carrier of the fork-lift truck. If there are other sections in the hydraulic system that has other pressure levels that are not proportional to the pressure used for the hydraulic section that acts up on the load carrier, these sections are not relevant for the present invention. Of course if the entire hydraulic system has a hydraulic pressure that corresponds to the pressure that is actuating on the load carrier the hydraulic pressure signal P corresponds to the overall hydraulic pressure.

The method uses a pressure signal received from a hydraulic pressure detection device that is positioned arranged to be able to measure the pressure in the relevant section of the hydraulic system. The hydraulic detection device can be any kind of detection device suitable for giving a variable output corresponding to the hydraulic pressure measured, for example a ceramic membrane wire tension sensor.

The electronic load carrier unit receives a hydraulic pressure signal P and is arranged to be able to determine whether the hydraulic pressure signal P adopts a predetermined value, within a predetermined value range Pval. If a detection device is used in this method that gives an output in my an example of a predetermined range Pval could be 0-800 mV.

If the electronic load carrier unit determines the value to for example 800 mV then a determination that the load carrier is positioned on ail external object is determined by the electronic load carrier unit, or that the load carrier is supported by a fixed internal object of the fork-lift truck. I the load carrier is fully supported by the fork-lift itself a typical value for P would then be for example 1000 mV. The difference is thus applied by the electronic load carrier unit for determining if an external or internal object is supporting the load carrier or not.

To also further tune the method it is possible to perform a step IIIa where a time condition t is determined. This condition thus gives the possibility to set a time period for which the P takes the value it Pval, in order for the method to proceed to step IV. This means that short spikes where Pval is taken by P, does not give the electronic load carrier unit possibility to determine that the load carrier is supported by an external object.

The time condition t is typically a time period of 200 ms. But can be chosen to be any value that corresponds to the usage of the fork-lift truck that applies the method. For example if for some reason it is needed to travel with the fork-lift truck with the forks supported on ground/floor for time periods of 2000 ms this value can be applied for t.

When condition IV is fulfilled and thus the electronic load carrier unit has determined that the load carrier is supported by an external object. There is a possibility to proceed by indicating this to the operator of the fork-lift truck, in a step V, for example by a visual message on a display of the fork-lift truck. It is also thinkable to use an audio message, or both visual and audio. The operator of the fork-lift truck can thus act upon this message manually, for example by raising the load carrier of the fork-lift truck. Further below we explain a step VIII which gives the operator an explicit incentive to raise the load carrier.

In a further development the indication is determined obsolete by determining that P is no longer in the interval Pval. Of course it is thinkable to also here apply a time condition t2 for exiting the determination that the load carrier is supported by an external object or a fixed internal object of the fork-lift truck. This can have the same value as for the previous condition t or have an own value different from t.

The method can also comprise the step that if it is determined in step IV that said load carrier is at least partially supported by an external object, the method further comprises the steps to: VI send an indication to a control unit that is arranged to control the operation of the fork-lift truck

The method can also include a further step VII to initiate by means of the control unit a movement for removing the load carrier from the external object, preferably by lifting the load carrier. Step VII is not to be performed if the load carrier is supported by a fixed internal object of the fork-lift truck, as this condition in general is fulfilled when picking up a load, thus possibly making loading of a load difficult, as the load carrier moves unintentionally.

The control unit can perform lifting for a predetermined time period t22, and there after end the lifting.

This means that a control unit controlling the lifting mechanism on the fork-lift truck can receive an indication and act independently on this indication. This does not exclude that an indication is sent to the operator as described above. It is also possible to end the initiated movement if P is no longer within Pval. And as above it is possible to apply a time condition t3 which can be different from both t2 and t but can also have the same value as either t or t2 or both.

In a further development the electronic load carrier unit determines the hydraulic pressure signal P continuously. This means that step I is performed continuously and in parallel with other steps of the method, of course if the fork-lift truck is not in operation this continuous determination can be in a resting mode.

The method further comprises a step VIII where the control unit reduces the maximal travel speed of the fork-lift truck. This travel speed reduction is preferably only valid as long as it is determined in step IV that the load carrier is supported by an external object or a fixed internal object of the fork-lift truck. If P does not equal Pval, and also preferably time condition t is not fulfilled, then travel speed is not reduced and thus travel speed is allowed up to maximal travel speed.

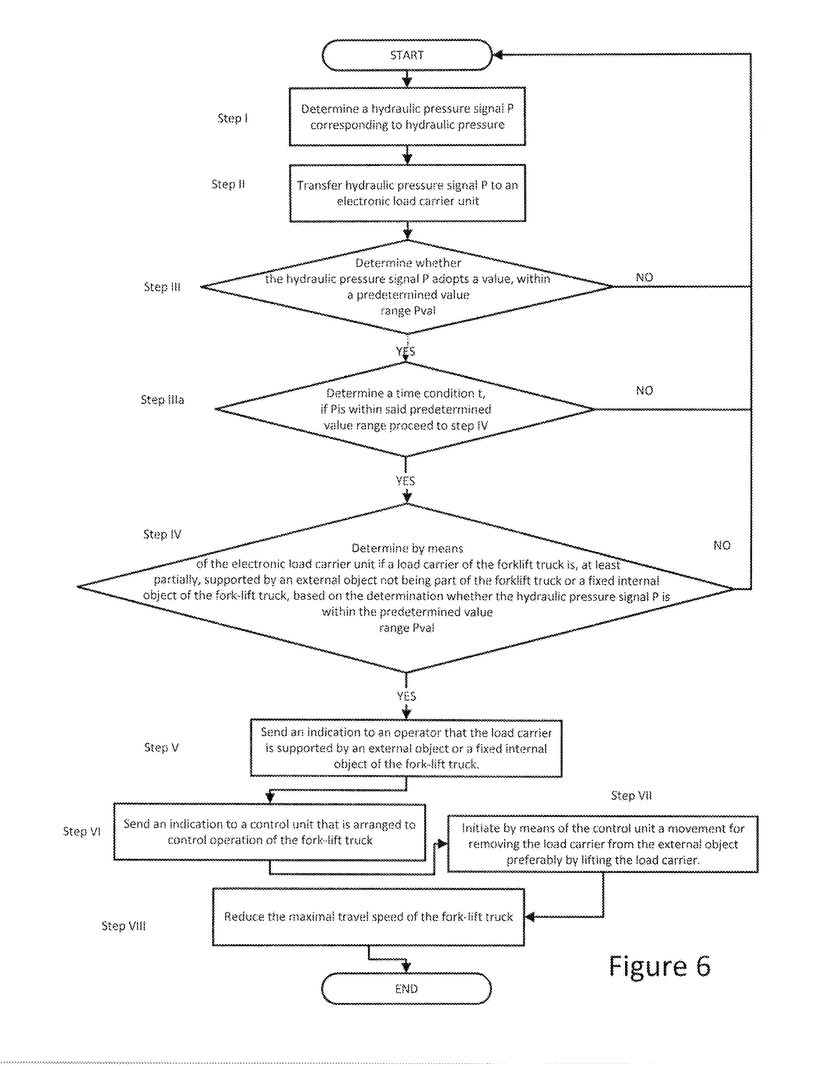

For an example of the method see FIG. 6. FIG. 6 docs not disclose all alternatives for example can step VIII be performed before step VI. Thus the maximal speed of the fork lift truck is reduced before the indication is sent to the operator etc.

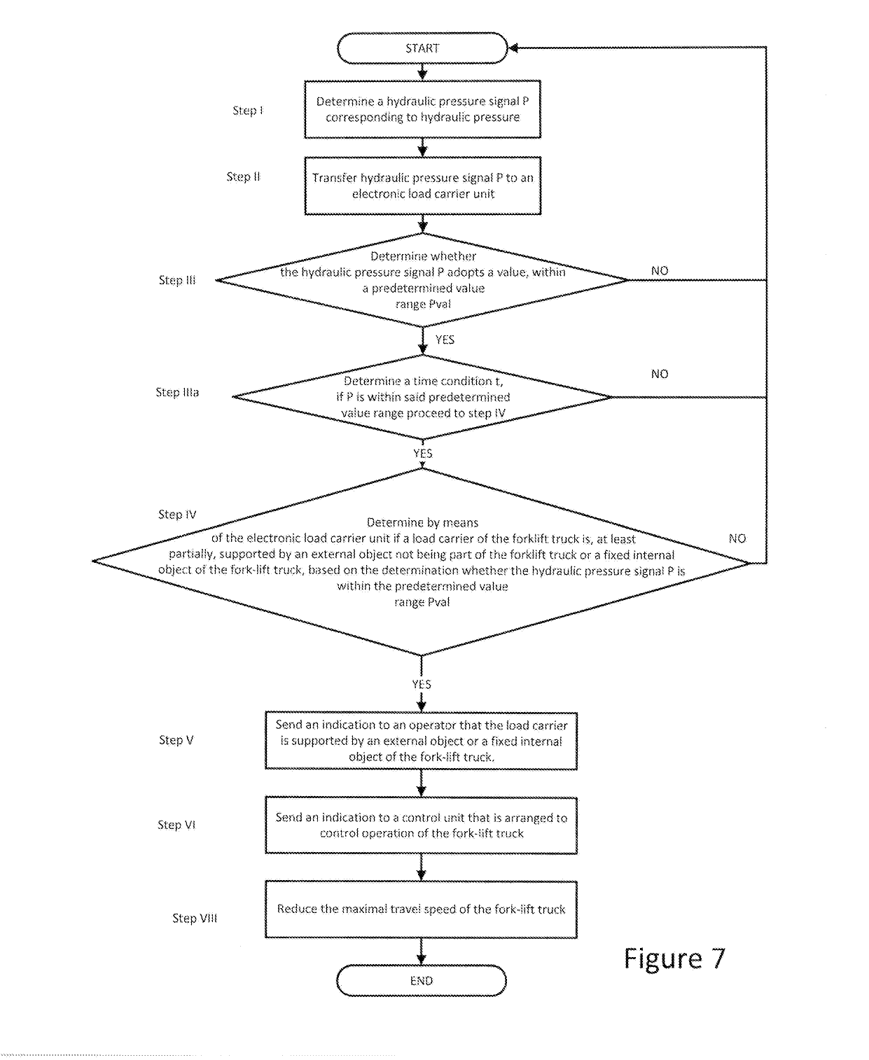

FIG. 7 discloses an embodiment of the method where there is no step VII and thus consequently no automatic movement of the load carrier. Thus the maximal travel speed of the fork-lift is reduced, but no lifting or movement of the load carrier is initiated automatically.

For all steps and referring to FIGS. 1, 6 and 7, it should be understood that end is a schematic end, and of course in general the method will continue from beginning.

A computer program product, comprising computer readable cod that when executed on an electronic load carrier unit performs the method according to the above is also part of the subject matter. This means that the code is executed by the electronic load carrier unit. It can be transferred to this unit for being executed but is preferably stored in a memory unit of the electronic load carrier unit.

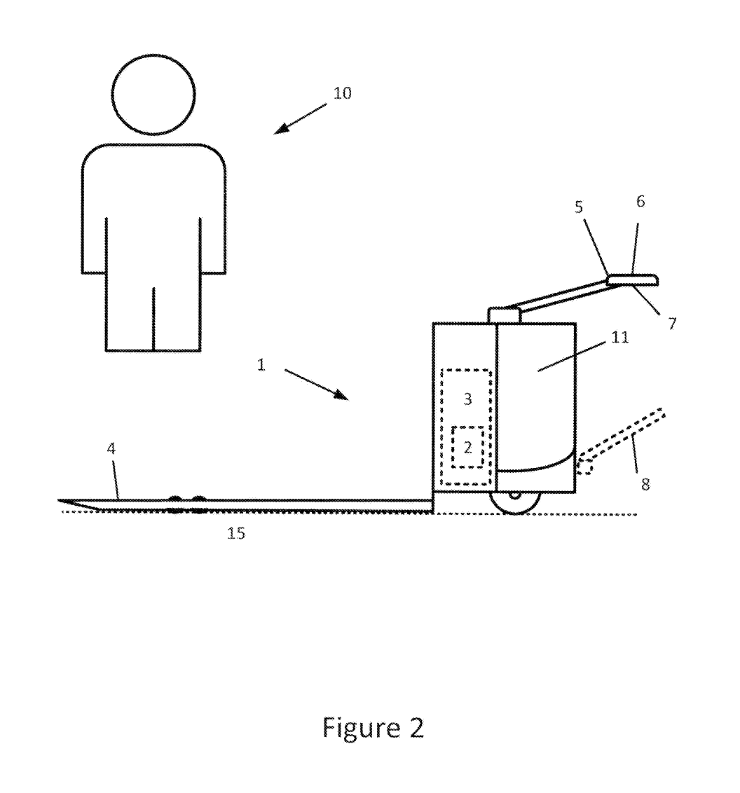

It is further disclosed a fork-lift truck 1 as in FIGS. 2, 3, 4, and 5 which will now be further discussed. The disclosed fork-lift truck is disclosed as a low lifter fork-lift truck. But could be a truck having a mast and thus being able to fetch and leave a cargo on a shelf. Also the fork-lift truck can be a fork-lift truck where the operator 10 can travel with it, for example by means of a pivotable platform 8, as disclosed in FIG. 2-5, or it can be a fork-lift truck not allowing the operator 10 to travel with it. The fork-lift truck 1 is preferably an electrically powered fork-lift truck 1 that has an electrical drive motor and an electrical pump motor pumping hydraulic fluid.

The fork-lift truck 1 in FIG. 1 discloses a detection device 2. The detection device is in general integrated into the hydraulic system 3 of the fork-lift truck 1. This is preferably done in the main hydraulic block of the system, (not shown). This block in general contains the valves of the hydraulic system and is feed from the hydraulic pump and is in contact with a non-pressurised reservoir of hydraulic fluid. The detection device comprises preferably a membrane with for example a thread tension sensor that gives an electric output.

The fork-lift truck 1 further comprises a load carrier 4 as mentioned above. The load carrier is preferably as seen in the FIGS. 2-5, a pair of forks. Of course the load carrier could be more than two forks and fewer than two forks if desired. However a load carrier in the form of a ladle would not be applicable for this application as it is intended to be in contact with an external object 20 or a fixed internal object of the fork-lift truck, in another manner than a fork-lift truck. However for example a grip device that performs the same tasks as forks but by gripping a load would be included.

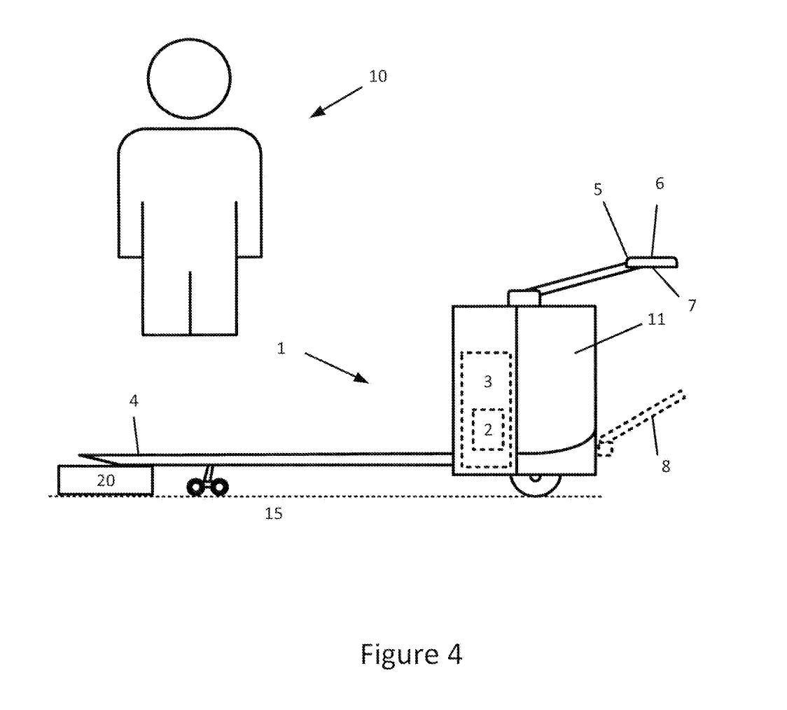

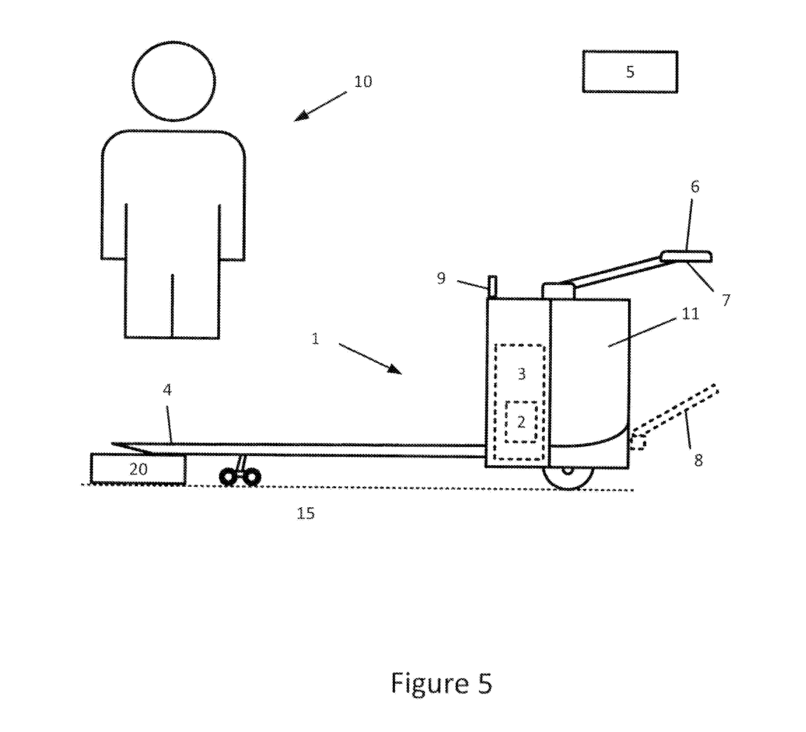

With regard to the external object disclosed in the FIGS. 4 and 5, it should be understood that it need not be an object per se, but could of course be the ground or floor 15 on which the fork-lift truck is supported, for example if the floor 15 is uneven. The schematic object 20 should be understood to be an object supported on the ground or for example a shelf on which a load has been laid. It should be understood that the external object 20 could be an object that does not belong to the fork-lift truck but jams the lifting mechanism of this fork-lift truck.

The discussed a fixed internal object of the fork-lift truck should be understood as being for example a hydraulic piston of the hydraulic system 3 that attains its shortest length, i.e. the least extended state, the load carrier 4 will then be supported at least partially on the rim/or the housing of the hydraulic piston. The hydraulic piston is thus being supported on the bottom of the hydraulic cylinder which in turn is supported in the housing 11 of the fork-lift truck. Thus the load carrier 4 cannot be lowered further. Thus the load carrier 4 will be not only supported by the hydraulic fluid pressure but also mechanically by the fixed object. Thus a fixed internal object not generally being as part/element that extends with the hydraulic piston when it extends. Other internal objects that will support the load carrier 4 when the load carrier is in the lowest position is also to be understood as being included in this definition for example it could be a pair of support legs or other protruding fixed objects limiting the movement of the load carrier 4 in the direction downwards. The fixed internal object is part of the fork-lift truck.

The fork-lift truck of FIGS. 2-4 has an on board electronic load carrier unit 5. This unit is here disclosed as being situated in the handle 7 of the fork-lift truck 1. The electronic load carrier unit 5 can be a separated control unit, comprising processor, memory and circuits for performing the discussed method, and housing the computer program product discussed above. The load carrier unit 5 can preferably be integrated into a control unit 6 of the fork lift truck 6. This control unit 6 being a main control unit for the fork-lift truck 1. The control unit 6 is for this assignment arranged to be able to control and monitor essentially all functions of said fork-lift truck, in particular wherever applicable, lifting, lowering, travel speed, safety functions, horn, weight limitations, height limitations, height pre-sets, acceleration, deceleration, power regeneration, display functions. The main control unit 6 is for the industrial truck of FIG. 2-4 situated in the handle 7 of the fork-lift truck 7. The main control unit 6 has an overall control possibility of the fork-lift truck 6. The fork-lift truck 6 cannot function if the main control unit 6 is removed from the fork-lift truck 6. The control unit 6 can also be positioned at a different position than the handle 7. The control unit 6 can be positioned in the housing 11 of the fork-lift truck 1.

In another embodiment as shown in FIG. 5, the electronic load carrier unit 5 is an external unit. This means that the fork-lift truck 1 must communicate with the load carrier unit 5 by means of a communication device 9. This can preferably be a wire-less link. The communication device 9 comprises thus an antenna and is preferably controlled by the control unit 6 of the fork-lift truck 1.

The fork-lift truck of FIG. 2, discloses the load carrier 4 in a position where it is by the floor/ground 15, for example where the floor ground is uneven. In general FIG. 2 is not applicable for the method or the fork-lift truck 1 performing the method on a flat floor. However, when the load carrier 4 is in a low or the lowest position, the clearance to the floor/ground is very small and subject any irregularities in the floor/ground 15 the forks will be supported by the ground/floor, or touch it. This is exemplified in FIG. 2.

We will now discuss the function of the method, computer program product and the fork-lift truck 1.

An operator 10 uses the fork-lift truck 1 for acquiring a load. After he has delivered the load to a receiver, he will start operating the fork-lift truck to drive it to a new load. The forks may then be positioned as disclosed in FIG. 2. If the forks are positioned in this position the detection device 2 will detect a pressure P that is in a predetermined interval Pval. The reason for this is that the internal pressure in the hydraulic system 3 for at least the section that powers the load carrier 4 is lower as it need not bear the full weight of the load carrier 4. As this situation occurs preferably a time condition t applies in the method discussed above and when this time condition is fulfilled, the following occurs. An indication that the load carrier 4 are supported on an object 15/20 is determined and an indication of this is provided to the operator 10, or the indication is transferred from the electronic load carrier unit 5 to the control unit 6 which then is arranged to have the load carrier lifted. The operator 10 may decide to manually raise the load carrier 4 when receiving the indication. Preferably the indication and the raising of the load carrier 4 is ended when P no longer equals Pval, subject a new time condition t2.

It is also possible to apply a time condition for lifting time t22, as discussed with regard to the method above, that functions as follows, when the operator receives an indication that the load carrier 4 is supported by an external object 15/20 if the operator 10 then raises the load carrier for a determined time period t22, the indication to the operator 10 is set to no longer apply. This time condition t22 can also apply for the automated lifting/movement of the load carrier 4 through the control unit 6. Then the load carrier 4 is stopped after t22 is fulfilled.

In a further development t22 is a sum of smaller lifting periods where t22 is an accumulated value. Applicable for both the method the computer program product and the fork-lift truck 1.

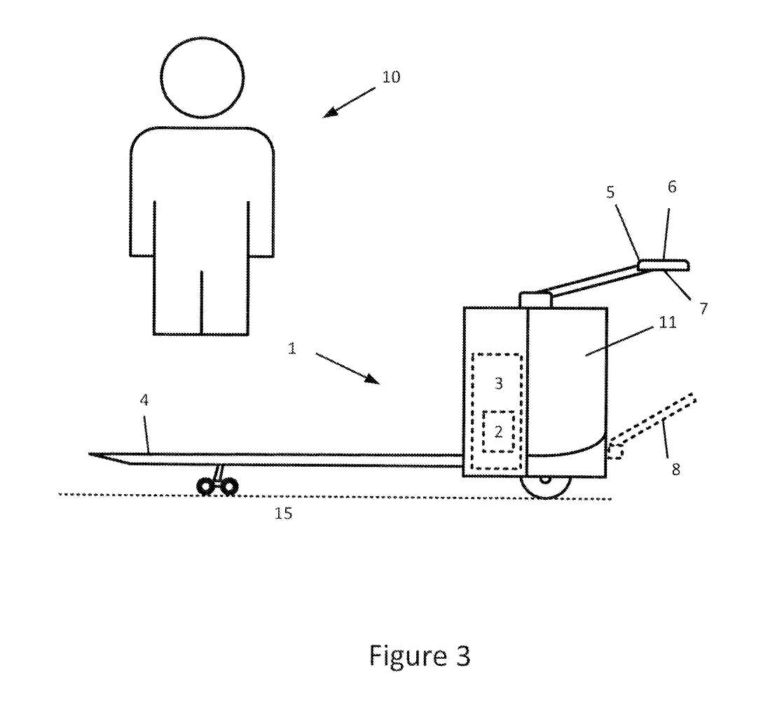

P is thus lower than if the forks are free for travel as disclosed in FIG. 3, where P not in Pval.

The control unit 6 can also limit the maximal travel speed of the fork-lift truck 1 if P=Pval, and optionally also the time condition t is fulfilled. This is preferably done when an indication is sent to the operator, or even before an indication is sent to the operator. The limitation to the maximal travel speed is removed if it is determined later in time that the forks are no longer supported by an external object. This limitation of the travel speed is of course applicable for the method, the computer program product and the fork-lift truck 1.

1. A method of operating a forklift truck, said method comprising:
receiving a hydraulic pressure signal P from at least one detection device, wherein the hydraulic pressure signal P corresponds to hydraulic pressure in at least a section of hydraulic system of a fork-lift truck;
transferring said hydraulic pressure signal P to an electronic load carrier unit;
determining by means of the electronic load carrier unit whether the hydraulic pressure signal P adopts a value within a predetermined value range Pval;
determining by means of the electronic load carrier unit if a load carrier of the forklift truck is at least partially supported by an external object not being part of the forklift truck or a fixed internal object of the fork-lift truck based on the determination whether the hydraulic pressure signal is within the predetermined value range Pval; and
sending an indication to an operator that the load carrier is supported by the external object or the fixed internal object of the forklift truck, if said load carrier is determined to be at least partially supported by the external object or the fixed internal object of the fork-lift truck.

2. The method according to claim 1, including:
determining a time condition t, if P is within said predetermined value range after determining whether the hydraulic pressure signal P adopts a value, within a predetermined value range Pval; and proceeding to determining if a load carrier of the forklift truck is at least partially supported by an external object not being part of the forklift truck or a fixed internal object of the forklift truck, based on the determination whether the hydraulic pressure signal is within the predetermined value range Pval, if said time condition t is fulfilled.

3. The method according to claim 2, wherein said time condition t is a predetermined time during which P has taken a value within the predetermined value range Pval.

4. The method according to claim 1, wherein said electronic load carrier unit receives the hydraulic pressure signal P continuously.

5. The method of operating a forklift truck according to claim 1, further comprising:
sending the indication that the load carrier is supported by the external object or the fixed internal object of the fork-lift truck to a control unit arranged to control the operation of the fork-lift truck and
reducing the maximal travel speed of the fork-lift truck while the load carrier is supported by the external object or the fixed internal object of the fork-lift truck.

6. A method of operating a forklift truck, said method comprising:
receiving a hydraulic pressure signal P from at least one detection device, wherein the hydraulic pressure signal P corresponds to an hydraulic pressure in at least a section of hydraulic system of a fork-lift truck;
transferring said hydraulic pressure signal P to an electronic load carrier unit;
determining by means of the electronic load carrier unit whether the hydraulic pressure signal P adopts a value within a predetermined value range Pval;
determining by means of the electronic load carrier unit if a load carrier of the forklift truck is at least partially supported by an external object not being part of the forklift truck or a fixed internal object of the fork-lift truck based on the determination whether the hydraulic pressure signal is within the predetermined value range Pval, and
sending an indication to a control unit controlling operation of the fork-lift truck that the load carrier of the forklift truck is at least partially supported by an external object not being part of the forklift truck or a fixed internal object of the fork-lift truck.

7. The method of operating a forklift truck according to claim 6, including
initiating by means of the control unit, a movement for removing the load carrier from the external object by lifting the load carrier.

8. The method according to claim 7, wherein lifting the load carrier is performed for a predetermined time period, and thereafter ended.

9. A computer program product comprising:
computer readable code, that when executed performs the steps of
receiving a hydraulic pressure signal P from at least one detection device, wherein the hydraulic pressure signal P corresponds to a hydraulic pressure in at least a section of a hydraulic system of a fork-lift truck;
transferring said hydraulic pressure signal P to an electronic load carrier unit;
determining by means of the electronic load carrier unit whether the hydraulic pressure signal P adopts a value within a predetermined value range Pval;
determining by means of the electronic load carrier unit if a load carrier of the forklift truck is at least partially supported by an external object not being part of the forklift truck or a fixed internal object of the fork-lift truck based on the determination whether the hydraulic pressure signal is within the predetermined value range Pval, and
sending an indication to an operator that the load carrier is supported by the external object or the fixed internal object of the fork-lift truck, if said load carrier is determined to be at least partially supported by the external object or the fixed internal object of the fork-lift truck.

10. A fork-lift truck comprising:
a hydraulic system;
a load carrier;
at least one hydraulic pressure detection device arranged to generate a hydraulic pressure signal P corresponding to a hydraulic pressure in at least a section of the hydraulic system;
wherein the forklift truck further includes, or is in communication with an electronic load carrier unit arranged to receive said hydraulic pressure signal P, determine whether the hydraulic pressure signal P adopts a value within a predetermined value range Pval, determine if the load carrier of the forklift truck is at least partially supported by an external object not being part of the forklift truck or a fixed internal object of the fork-lift truck based on the determination whether the hydraulic pressure signal is within the predetermined value range Pval, and send an indication to an operator that the load carrier is supported by an external object or a fixed internal object of the fork-lift truck, if said load carrier is determined to be at least partially supported by an external object or a fixed internal object of the fork-lift truck.

11. The fork-lift truck according to claim 10, further comprising a control unit arranged to reduce the maximal travel speed of the fork-lift truck when it is determined that P=Pval.

12. The fork-lift truck according to claim 10, wherein the fork-lift truck further comprises a communication device for communicating with the external electronic load carrier unit.

13. A fork-lift truck comprising:
a hydraulic system;
a load carrier;
at least one hydraulic pressure detection device arranged to determine a hydraulic pressure signal P corresponding to a hydraulic pressure in at least a section of the hydraulic system;
wherein the forklift truck further comprises, or is in communication with, an electronic load carrier unit arranged to receive said hydraulic pressure signal P, determine whether the hydraulic pressure signal P adopts a value within a predetermined value range Pval, determine if a load carrier of the forklift truck is at least partially supported by an external object not being part of the forklift truck or a fixed internal object of the fork-lift truck based on the determination whether the hydraulic pressure signal is within the predetermined value range Pval; and
a control unit arranged to control the movement of the load carrier based on the determination if a load carrier of the forklift truck is at least partially supported by an external object not being part of the forklift truck or a fixed internal object of the fork-lift truck.

14. The fork-lift truck according to claim 13 wherein said control unit is a main control unit arranged to control and monitor functions of said fork-lift truck said functions of said fork-lift selected from a group of functions consisting of lifting, lowering, travel speed, safety functions, horn, weight limitations, height limitations, height pre-sets, acceleration, deceleration, power regeneration, and display functions.

15. The forklift truck according to claim 13, wherein the control unit is arranged to initiate a movement for removing the load carrier from the external object by lifting the load carrier.

16. The fork-lift truck according to claim 13, wherein said electronic load carrier unit is incorporated into the control unit of the fork-lift truck.

17. The fork-lift truck according to claim 10, further comprising a control unit arranged to reduce the maximal travel speed of the fork-lift truck when it is determined that P=Pval and a time condition is fulfilled.
